(19) United States
(12) Patent Application Publication
(10) Pub. No.: US 2014/0026088 A1
(43) Pub. Date: Jan. 23, 2014

(54) Data Interface Integrating Temporal and Geographic Information

(71) Applicant: Charles Monte, Palo Alto, CA (US)

(72) Inventor: Charles Monte, Palo Alto, CA (US)

(73) Assignee: SAP AG, Walldorf (DE)

(21) Appl. No.: 13/551,272

(22) Filed: Jul. 17, 2012

(51) Int. Cl. G06F 3/048

(52) U.S. Cl. 715/765

(57) ABSTRACT

A user interface (e.g. to a mobile device) integrates temporal and geographic information in an intimate and flexible manner. A view engine presents views of geographic information (such as points of origin, destinations, preferred/alternative routes) closely linked with associated time information (such as scheduled delivery times, current actual time, estimated transit times etc.). As a user manipulates an input (e.g. a timebar) to move forward and backward in time, the interface adjusts correspondingly to display geographic information relevant to the selected time. Conversely, as a user manipulates geographic information (e.g. a map), the interface may adjust correspondingly to display relevant temporal information. Time information may be afforded by the interface to the user through the use of color and/or movement of displayed items. As an aid to use, the interface may further include an input dedicated to returning the user to the present time and geographical location display.

### BACKGROUND

Embodiments of the present invention relate to data interfaces, and in particular, to a system and methods integrating time and geographic location information.

Unless otherwise indicated herein, the approaches described in this section are not prior art to the claims in this application and are not admitted to be prior art by inclusion in this section.

The increased power of portable computing devices (e.g. smartphones, tablets), has enhanced their adoption for a variety of purposes. Such devices afford both precise temporal and geographic information regarding a user. For example, geographic information is available from a number of sources, including maps and global positioning system (GPS) infrastructure.

Precise temporal information may be available from the internal clock of a portable device itself, as well as from wireless signals including GPS signals. The following table provides a listing of pervasive time information available by geographic location and frequency.

| Station | Location | Frequency | |
|---|---|---|---|
| WWV | USA | 2.5, 5, 10, 15, 20 | MHz |
| WWVB | USA | 60 | kHz |
| MSF | Britain | 60 | kHz |
| CHU | Canada | 3330, 7850, 14670 | kHz |
| BPC | China | 68.5 | kHz |
| BPM | China | 5, 10, 15 | MHz |
| TDF | France | 162 | kHz |
| DCF77 | Germany | 77.5 | kHz |
| JJY | Japan | 40, 60 | kHz |
| RBU | Russia | 66.66 | kHz |
| HBG | Switzerland | 75 | kHz |

Accordingly, the present disclosure relates to data user interfaces (UIs) that closely integrate time and geographic location information.

### SUMMARY

A user interface (e.g. to a mobile device) integrates temporal and geographic information in an intimate and flexible manner. A view engine presents views of geographic information (such as points of origin, destinations, preferred/alternative routes) closely linked with associated time information (such as scheduled delivery times, current actual time, estimated transit times etc.). As a user manipulates an input (e.g. a timebar) to move forward and backward in time, the interface adjusts correspondingly to display geographic information relevant to the selected time. Conversely, as a user manipulates geographic information (e.g. a map), the interface may adjust correspondingly to display relevant temporal information. Time information may be afforded by the interface to the user through the use of color and/or movement of displayed items. As an aid to use, the interface may further include an input dedicated to returning the user to the present time and geographical location display.

An embodiment of a computer-implemented method comprises causing an engine to receive temporal data from a source of time information, and causing the engine to receive geographic data from a source of geographic information. The method further comprises causing the engine to provide an interface comprising a map view synchronized with a list view according to a time, and causing the engine to change the interface according to a user input, such that synchronization between the map view and the list view is maintained.

An embodiment of a non-transitory computer readable storage medium embodies a computer program for performing a method comprising causing an engine to receive temporal data from a source of time information, and causing the engine to receive geographic data from a source of geographic information. The method further comprises causing the engine to provide an interface comprising a map view synchronized with a list view according to a time, and causing the engine to change the interface according to a user input, such that synchronization between the map view and the list view is maintained.

An embodiment of a computer system comprises one or more processors and a software program executable on said computer system. The software program is configured to cause an engine to receive temporal data from a source of time information, and to cause the engine to receive geographic data from a source of geographic information. The software program is further configured to cause the engine to provide an interface comprising a map view synchronized with a list view according to a time, and to cause the engine to change the interface according to a user input, such that synchronization between the map view and the list view is maintained.

In some embodiments the user input is provided to a timebar.

According to certain embodiments the user input comprises interacting with the timebar moveable within a lens portion.

In particular embodiments the user input comprises interacting with the timebar comprising a playable frame portion.

According to various embodiments the user input comprises a current location according to a global positioning system (GPS) signal, or comprises a past, present, or future location.

In certain embodiments the user input comprises a current time according to pervasive time signal, or comprises a user-selected past, present, or future time.

According to some embodiments the time is indicated by an affordance comprising color.

The following detailed description and accompanying drawings provide a better understanding of the nature and advantages of particular embodiments.

### BRIEF DESCRIPTION OF THE DRAWINGS

FIG. 1 shows a simplified diagram illustrating a system according to an embodiment.

FIG. 1A shows a simplified flow diagram illustrating an embodiment of a process of providing a user interface.

FIGS. 2A-2J show screen shots of an example of an embodiment of a user interface for a tablet device.

FIGS. 3A-3M4 show screen shots of an example of an embodiment of a user interface for a smart phone device.

FIG. 4 illustrates hardware of a special purpose computing machine configured to provide a user interface according to an embodiment.

FIG. 5 illustrates an example of a computer system.

FIGS. 6A-B illustrate various embodiments of timebars.

### DETAILED DESCRIPTION

Described herein are systems and methods implementing a user interface featuring an intimate relationship between temporal and geographic information. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments relate to user interfaces utilizing Advanced Mobile Patterns (AMP)—multifaceted data visualization experiences involving an intimate relationship between temporal and geographic information. Activities implicated in the AMP range from simple UI behaviors, tasks and navigation solutions, to complex visualizations integrating interoperable dimensions of time and location.

Various embodiments of AMP UI solutions may comprise native controls and behaviors, and/or deploy custom controls, interactions, animations, and transitions. Pattern attributes are mechanisms used for data visualizations and interactions, and may include but are not limited to:
Navigation and Focus Methodologies and Behaviors
Transitions
Indications, Affordances and Animations
Screen Interactions, Views and Orientations (Zoom, Floor-plan layouts, Scroll, Drop/Drag, etc.)
Controls and Interactions
Device Man-Machine Interface (MMI) Operations (Touch Gestures, Joystick, Hardware Keys, etc.)
Device Resources (Sensors, Camera, Clock, GPS, Notifications, etc.).

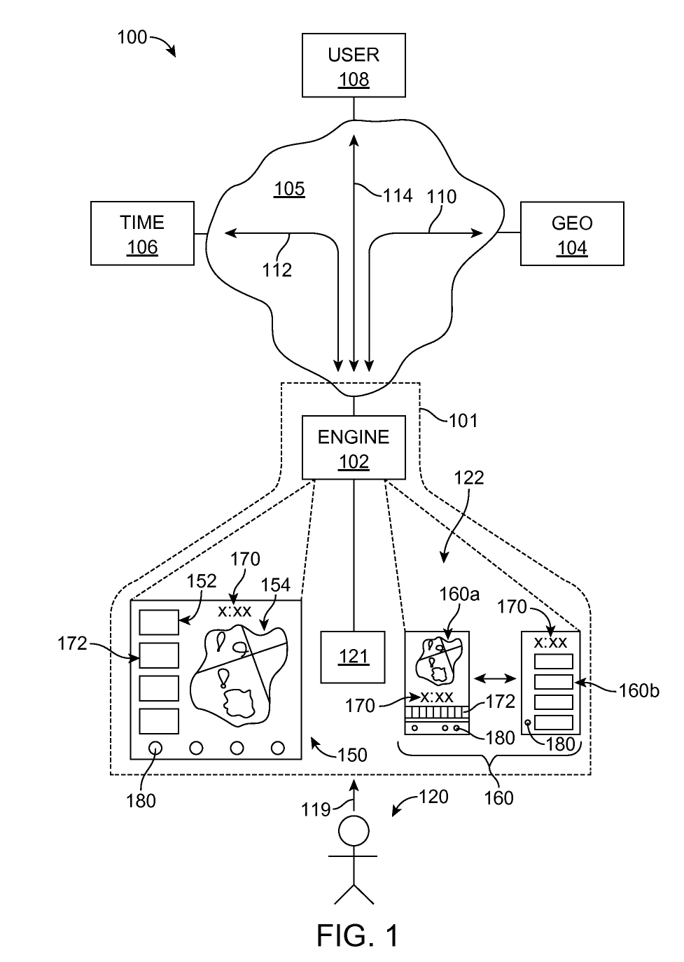

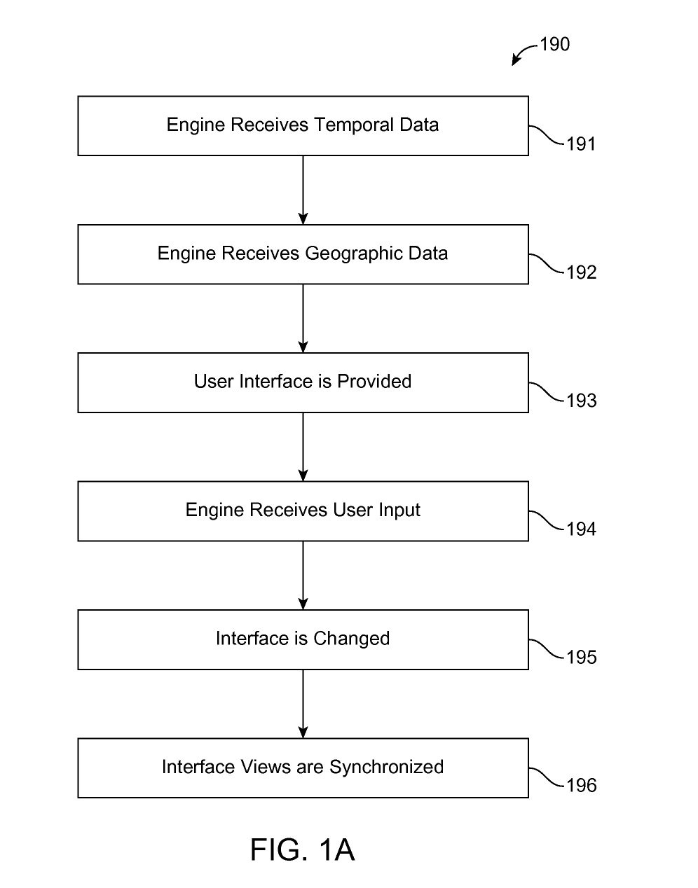

FIG. 1 shows a simplified view of a system 100 that is configured to provide a user interface to a mobile device 101 according to an embodiment. In particular, processing engine 102 is in communication with a source 104 of geographic information. Examples of such geographic information include but are not limited to mapping resources and GPS systems. This source of geographic information may be located internal to the mobile device, or may be remote therefrom and accessed through a communications network 105.

Processing engine 102 is also in communication with a source 106 of temporal information. Examples of such temporal information include but are not limited to a wireless time signal, and an internal clock of a mobile device.

Processing engine 102 is further also in communication with a source 108 of information specific to a particular user. Examples of such user information can include but is not limited to, calendar information, customer information, and vendor information such as may be available to enterprise resource planning (ERP) software applications. This source of user information may be located internal to the mobile device, and/or may be remote therefrom and accessed through the communications network.

The input of user information in the form of data display selections for time and location and events, may allow an interface to present complex visualizations. For example according to various embodiments, affordances such as color and/or graphical animations could be employed to present an interface synchronized with relevant temporal and geographic information.

Engine 102 is configured to receive inputs in the form of geographic information 110, temporal information 112, and/or user information 114, from the respective sources 104, 106, and 108. Engine 102 is further configured to process these inputs, as well as inputs 119 from a user 120 to an input mechanism 121 (e.g. touch screen, keypad, touch pad, voice recognition, mouse, physical device sensors) of the mobile device, and in response generate a corresponding user interface 122. As explained in detail herein, this user interface 122 is configured to integrate at least the geographic and temporal information, in an intimate and flexible manner.

FIG. 1 shows the user interface as comprising two possible configurations. A first UI 150 relates to a mobile device having a screen of sufficient size (e.g. table, laptop) to comfortably accommodate a plurality of UI attributes and views for a user. In the user interface 150, these UI attributes and views comprise a list view 152 and a map view 154.

A second user interface 160 of FIG. 1, relates to a mobile device having a screen of a smaller size (e.g. smart phone) insufficient to comfortably accommodate a plurality of UI attributes and views. Accordingly, this user interface comprises a first screen comprising a map view 160a, and a second screen comprising a list view 160b.

As is discussed in detail below, whether configured on a tablet, laptop, or smart phone, embodiments of user interfaces may share some common features. One common feature as already described, is the use of a list view incorporating temporal information, coordinated with a map view including geographic information.

Another feature that may be common to embodiments of UIs, is the display of a running clock 170 indicating a current time. Still another feature that may be common to user interface embodiments, is an input functionality 172 allowing the user to select a time for the interface. In the interface 150, this input functionality may comprise a vertical timebar. In the interface 160, this input functionality may comprise a horizontal timebar.

Yet another common feature may be a button or other input functionality 180 allowing a user to immediately return the interface display to the current time and corresponding geographical information. As described below, the state of the effective time of the interface (e.g. past, present, or future) may be indicated to a user through a plurality of different types of affordances (including colors, animations, and spatial screen locations. However the input functionality 180 may be useful in aiding a user (and particularly a novice user) to remain oriented in the temporal aspect of the interface.

As explained in detail below in conjunction with specific examples, user interfaces according to various embodiments may exhibit one or more of the following features.

A user interface according to embodiments may display a running clock that persistently communicates and indicates existing clock time as a constantly advancing dimension in various views. In certain embodiments, data relating to the existing clock time may be indicated to a user by the use of a particular color and/or graphical indication.

A UI according to certain embodiments may integrate time and location information. Selected or focused date/time information may be paired with corresponding map and list views.

A user interface may include time and location pairing affordances. In particular, certain embodiments may assume that it is not possible to be in more than one location at the same time. Arrangement of locations according to times, duration, and in-between travel time/distance, implies a natural sequential order of locations (hereafter “route”). Embodiments may display indications and affordances for clearly matching map locations with time-arranged locations in a list or timebar control indications according to the corresponding implied sequential order.

A user interface according to particular embodiments may allow the user to essentially move forward and backward in time. The user may utilize the UI to select views linking temporal and geographic information in the past, present, and future.

Manipulation of the view to achieve movement through time, may be accomplished in a number of ways. One approach utilizes a time sliding experience, wherein the interface imparts the perception of directional movement through time (sliding) via techniques such as screen visualizations, transitions, and animations.

The flexible access, display, and modification of temporal information may comprise one novel aspect of user interfaces according to various embodiments. In order to allow for rapid and reliable re-orientation to the current time, embodiments may include a simple, quick control mechanism returning the display to the current time. Thus some embodiments may provide a universal, quickly-recognizable action button/icon to quickly return to the current real time and corresponding map/list view in any screen and state.

User interfaces according to embodiments may provide here/now affordances—clear and obvious indications of when the user is accessing here/now geographic/temporal information, as opposed to a day/time in the past or future. Again, differing color schemes may be employed to indicate to a user data relevant to the present time, to past time, or to future time. Other types of affordances can comprise graphical information such as shapes, icons, etc., as well as animations.

Embodiments may provide views of information in the form of lists that integrate time indications (which may be real time or near-real time) and affordances. Where permitted by available display space, such list views may appear on the same screen with geographic information. Alternatively, list views may be presented on a separate screen with toggling or other action permitting user access between lists and map information.

Embodiments of interfaces may provide status indications to a user. Particular embodiments may persistently display a recognizable indication for a status of an event in both list and map views, e.g. via an icon common to both.

Embodiments may display a sequential order of locations (e.g. a route) according to relevant time information. Thus an embodiment may persistently provide a recognizable indication for the sequential order of events in both a list view and a map view, via an icon.

Embodiments may provide contextually relevant views to a user. Thus an interface may programmatically present a user-relevant context for content and data visualizations in screen views. For example, by default a landing screen may persistently display a current day according to a clock and calendar and automatically manipulate the interface to show object data of particular user relevance.

Embodiments may furnish time-relative position affordances within a route. An interface may persistently provide recognizable affordances for a user's relative position in a route according to time (e.g. where they were, where they are, and where they are going). Positions may be calculated or forecasted locations, GPS, or other map location indications as applicable to a particular use case.

Embodiments may provide affordances that aid a user in intuitively grasping the movement of time and geographic information. Thus where appropriate, after making a selection that results in a new screen view, embodiments of user interfaces may persistently provide recognizable contextual navigation affordances (e.g. an animation) indicating where the user navigated from.

FIG. 1A shows a simplified flow diagram of a process 190 according to an embodiment. In a first step 191, an engine receives temporal data from a source of time information. In a second step 192, the engine receives geographic data from a source of geographic information. In a third step 193, the engine provides to a user device, an interface comprising a list view synchronized with a map view. In a fourth step 194, the engine receives a user input to the interface. In a fifth step 195, the engine changes the interface according to the user input. In a sixth step 196, the engine updates synchronization of the list and map views according to the changed interface.

### EXAMPLES

User interfaces according to embodiments may be particular useful for use in conjunction with mobile devices. The following provides a description to two types of mobile devices: a table device having screen of sufficient size to simultaneously display a plurality of attributes and different views (e.g. a map view and a list view) in a manner comfortable to a user, and a smart phone device having a smaller screen. However, these are examples only, and features of either type of display may be applicable to other device types.

Tablet

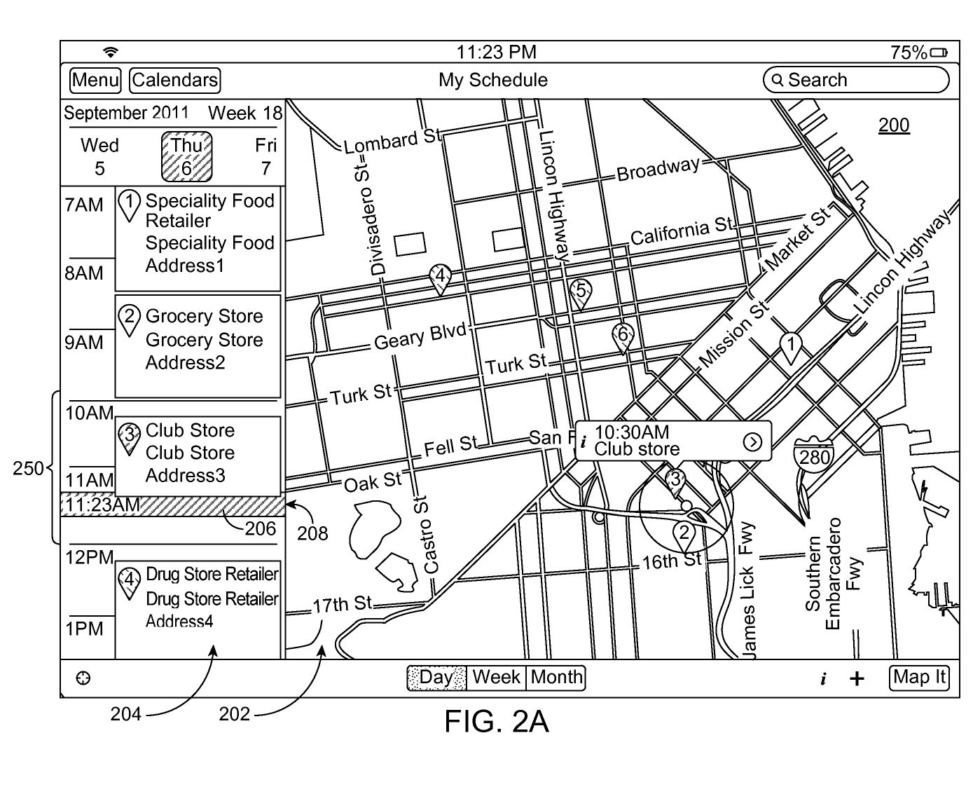

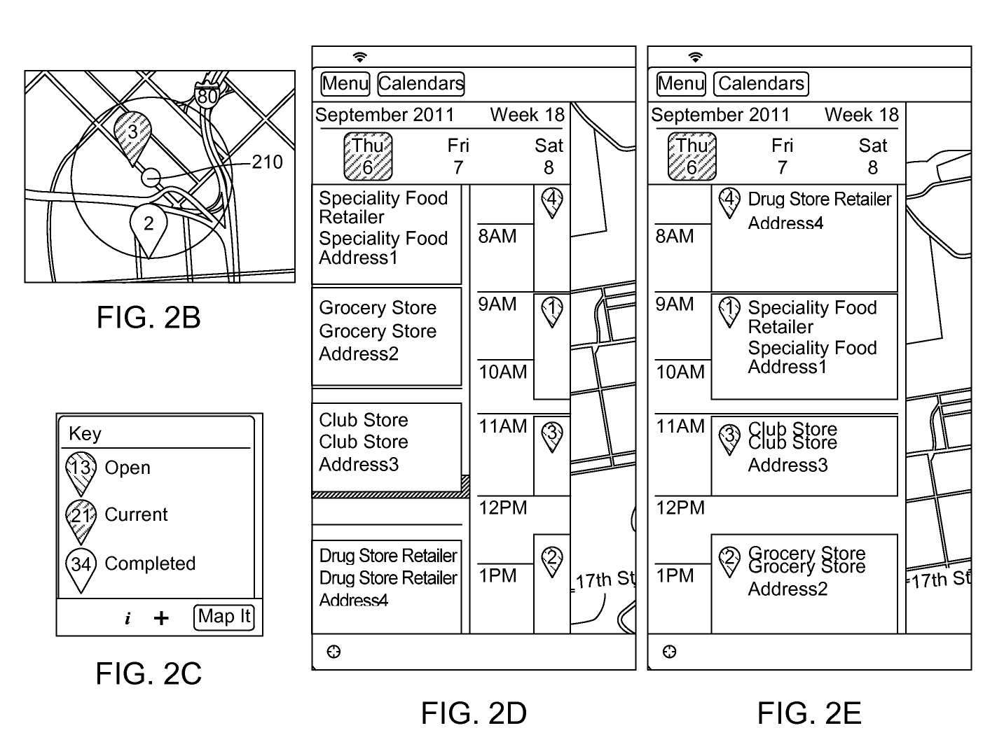

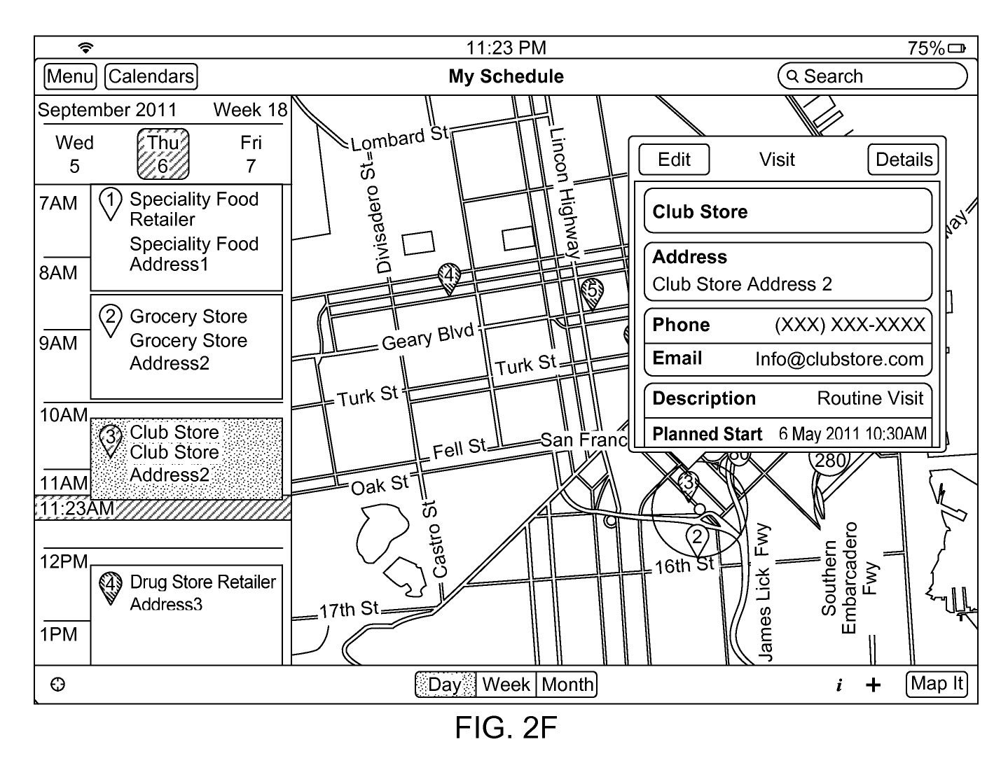

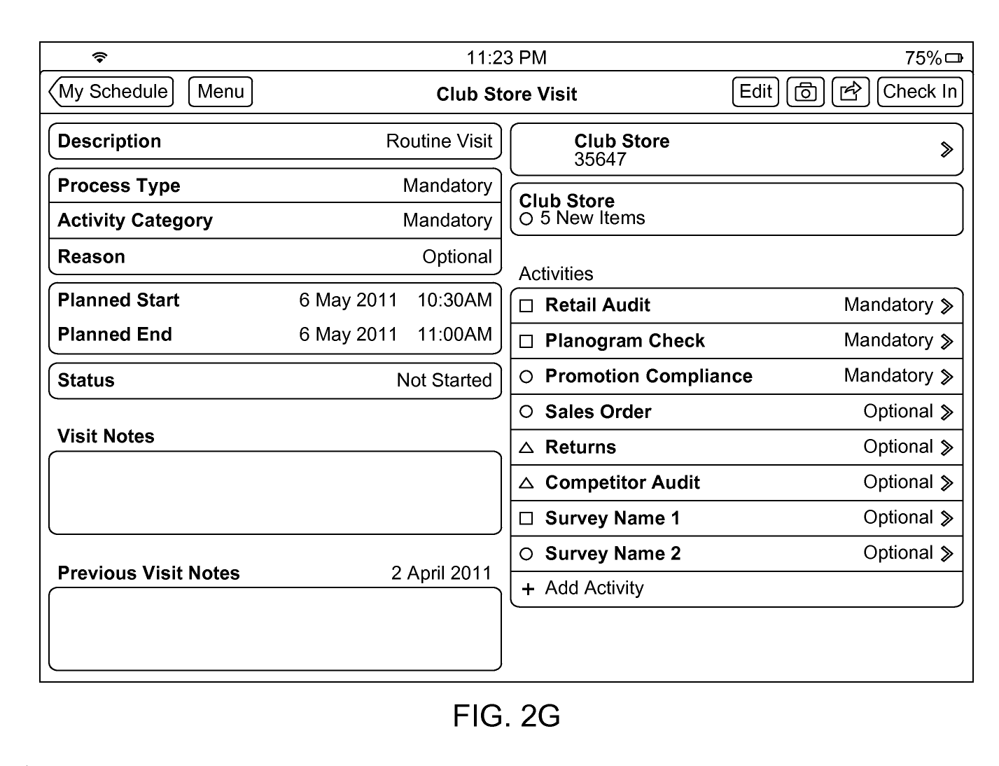

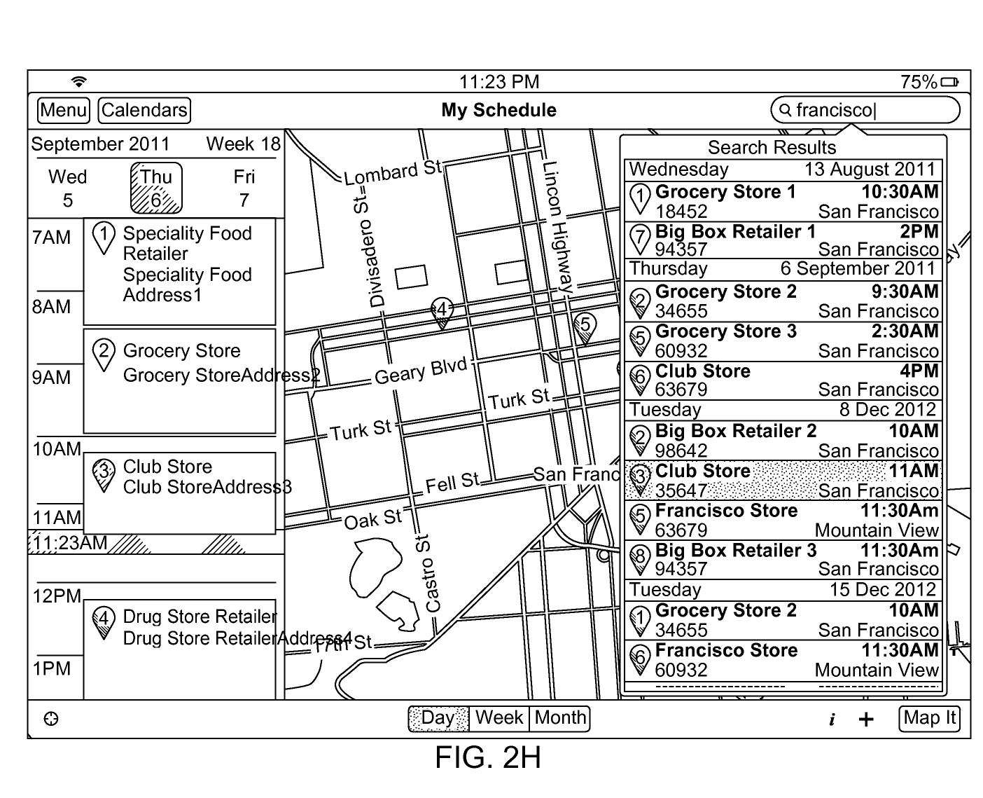

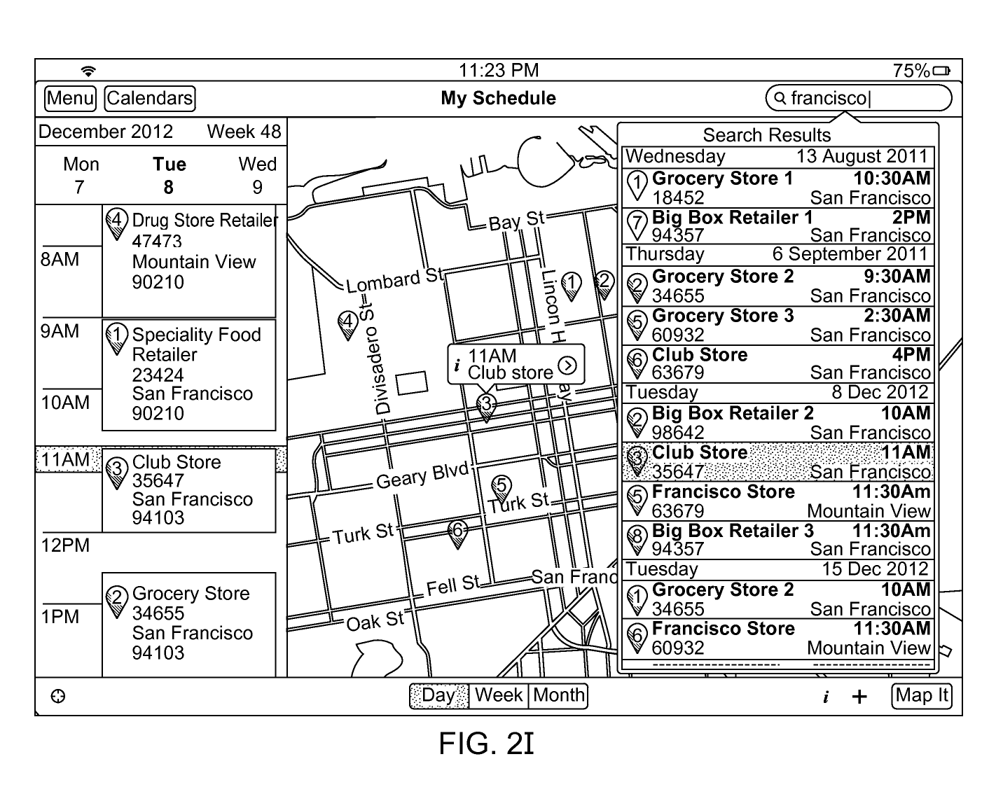

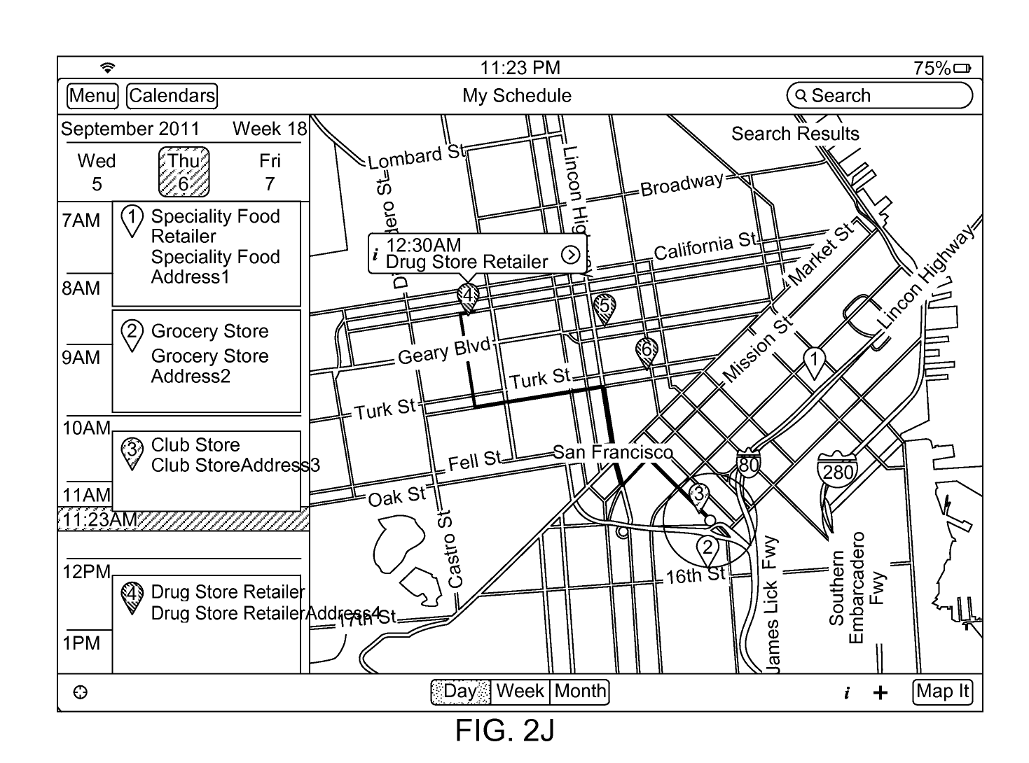

FIGS. 2A-2J show screen shots of an example of an embodiment of a user interface for a tablet device. FIG. 2A is a landing screen for this user interface showing the Here/Now default view for the tablet platform.

In Tablet device formats both the map view 202 and list view 204 may be displayed on a single screen 200 floor-plan. This presents the opportunity for user interoperability between these two components in a unique way.

Generally, a user's selection on the map view will be indicated on the list—and a user's selection on the list will be indicated on the map view. These interoperations may be consistently deployed. Additionally the default landing view may present the current day's list and corresponding map.

A user interface for a tablet format may provide a plurality of affordances and Indications. The following are attribute examples from an embodiment. Developers may deploy these feature examples as designed or create customized versions.

The user interface may include a timebar with real time running clock indication.

The timebar is an attribute that may be integrated into the list component. A color 206 (e.g. gold) may persistently represent the current time as it moves down the list according to the real-time clock. It displays real clock time in numeric digits as well as indicates the current visit through the graphical intersection of the color-coded time indication bar 208 with the visit object in the list. The colon (:) between the numeric hour and minute display may flash on/off every 500 ms to communicate a real-time “running” clock.

Reference no. 250 hows an example of a time smart list with Here/Now TimeBar (11:23 AM) and its intersection with the in-process visit shown by the highlight applied to the List-Box Object.

Embodiments may offer pairing affordances between the list and map views. The Here/Now Default View (or Landing screen) shows the Costco Visit in-progress at 11:23 AM by the Here/Now TimeBar's intersection with the appointment “Box” and the colored PIN Icon in both the List Visit Box and on the Map. This demonstrates the adoption for providing “Pairing” Affordances between the list and the map. And so at-a-glance, the user is able to immediately recognize the current “Here/Now” activities in both List and MAP via the persistent color applied to list objects, timebar and map location PIN. Further, note the color highlight on the current day in the list header providing a confirming affordance for Thursday, September 6 as being the current day. Collectively, these affordances provide an easily recognizable visual confirmation for the “Here/Now” state.

The here/now color may not be used as a user selection indication. The here/now color as applied to various elements is programmatically indicated by the software according to the real-time clock and timebar intersection with a visit and corresponding Location PIN on the MAP.

The user interface may provide a GPS Indication as shown in FIG. 2B. A GPS Map indication epitomizes the context of Real-Time “Here/Now” on a MAP, and thus is colored and at the same time may flash On/Off every 500 ms to demonstrate its Real-Time attribute. When a user in in-route, the GPS indicator “DOT” 210 moves accordingly as is typical GPS functionality.

Also, a user's GPS position on or near a Location PIN can functionally interact with status indications, and even effect or automatically change visit schedule and/or duration times. According to certain embodiments, GPS UI indications could basically behave according to one or more of the following.
GPS Indication could move according to the current or last detected position of the device.
GPS indication could be persistently displayed with ALL the Visit Locations in a single zoomed-Map view.
When a GPS indication is in the vicinity of a Location PIN, it automatically opens the Small bubble corresponding to that PIN and indicates it as a Here/Now PIN with an appropriate affordance (e.g. color).

Some embodiments may utilize GPS Location Calculation Features. Examples include but are not limited to:
calculating distance and estimated travel time between visits or entire Route;
modifying Route according to position;
modifying Route according to position and traffic conditions;
re-scheduling times and order of visits in List and Map visualizations/views according to GPS;
running various comparative scenarios of the above as an aid for the user to regularly update the day's visit schedule and routes according to actual location and status inputs.
providing a UI (Filters, Views, Scenario Preferences) for selecting Assumption Logic used for various TimeSmart calculations and scenarios;
using GPS to identify customers in the vicinity;
using GPS to identify sales representative colleagues in the vicinity to make contact and collaborate;
using GPS to allow the user to send a quick pre-populated message to next customer visits: e.g. “On my way . . . ETA 1:34 pm, 5 miles away . . . ”;
using GPS to identify and display fuel stops nearby;
using GPS to identify and display food stops nearby;
using GPS to identify radar speed traps along a route; and/or
using GPS to identify and display weigh station locations or alternate routes around weight stations.

Interface embodiments may include location PINs with status and visit order indications. The default screen utilizes “PIN” Icons to locate a visit on the MAP and in each List Visit object. PIN icons provide the affordances for showing the Status of the Visit (Color) and the sequential order of Visits (Number or Letter). The Number indications are used to programmatically create and render the Route via the MAP-IT control (detailed later in this document). Depending on the application, one or more status “States” may be associated with a PIN as shown by the color assignment to the PIN Icon. FIG. 2C shows that 3 states are deployed. These States may be viewed by launching the PIN Key Popup FIG. 2C via the lower case (i) icon.

The default MAP view may provide contextual relevance to the user. Default MAP views may be programmatically zoomed and panned to display visit/PIN locations for the default Here/Now or user selected day. This eliminates the need for the user make unnecessary actions in order to view relevant data in the initially displayed MAP visualization. After default MAP Views are presented, the user may manually zoom In/Out and/or Pan to an alternate MAP view to further inspect detail street and route information.

The list view represents a “Slice” of a Calendar Day arranged in a vertical Time Grid. Visit Objects are arranged according to Time with the “Box” Height representing the Visit Duration, and space between each object representing the Route's Travel-Time between each Visit. As shown in FIGS. 2D-E, users may Swipe or Drag the List Left/Right (Backwards/Forward in Time) one day at a time from the List Surface. Dragging or Swiping the Header Left/Right may move up to a maximum number of days (here 6) at a time. Also TAPPING on a day in the Header (e.g. the 6^{th} or the 8^{th} in FIG. 2E) may also invoke that selection. Swipe or Drag the list Up/Down to scroll to hidden time and Visit Objects. The centered Day in the Header indicates the selected day and corresponding MAP in view.

As shown in FIG. 2F, tapping on a Visit Object (Box) will display a Large-Bubble Detail Popover corresponding to that Visit. As shown in FIG. 2G, tapping on the large bubble may in turn reveal an entire screen with still further information.

Visit Objects may be edited within the List view. The ability for user editing of Visit Duration, Start/End Times and Visit Order may be implemented. User edits may be restricted to a certain day or days and/or Visit Status—for example not permitting editing of Visits that are completed, or have occurred in the past.

Visit Objects may be created by a user via either/both the List and Map views. The ability for a user to create a visit by selecting a location on the Map, or temporal position in the Time-Smart List, may be implemented. Creating Visit Object may also be programmatically generated from a backend system or another user of a backend system.

The following are details on the interactions for creating a Visit Object according to particular embodiments. Pressing and holding on a Map location will create a new PIN. A new PIN Default may provide for user to zoom-in and adjust the street location of the PIN. A detail create screen similar to FIG. 2G, may allow the user to enter visit details of time, Duration, Contacts, etc.

Creating a MAP PIN also inserts a Visit Box in the List. A user may select this Visit Object to further enter edit Visit data and parameters then “SAVE” the new Object.

A user may also “Long-Press” on a “Blank” area on the List to create a Visit Object. After entering time and map location data (for example in a form), the MAP PIN is programmatically created and located on the MAP corresponding to the new Visit Object created from the List.

Also the Rules associated with changing the order may have different requirements. FIG. 2J illustrates depiction of a route according to a user interface for a table platform. For example when inserting a Visit in-between other Visits, the interface may or may not keep intact the associated Travel-Times associated with the Visits, or even re-calculate new Travel-Times and Visit Start-Times based on a new order of Visits within the implied Route. Another possible Edit Rule may not allow changing past/completed Visit times and durations—but only for Current or Future Visits or appointments.

Logic associated with list views, especially editing, can become quite complex. Embodiments may support functional aspects of Selections and Editing, accommodating further development to establish the Logic Rules and requirements according to a particular use case. Basic Edit Functions are now described.

Embodiments may allow dragging and dropping visit objects to Edit Order and Corresponding Start/End Times. To move a Visit Object to a new Time, a user may Press, Hold and Drag up/down the list to the desired time; then release touch to “Drop” it in a new position within the list. If the new time of this action changes the order of the Visits, the Location PIN animation may be automatically invoked, and the corresponding visit order numbers inside the Location PINs on both the Map and List will be updated.

Depending on the Visit Durations and travel times of the existing visits, and according to the Object's “Drop” position, inserting a Visit Object between other Visits will move previous or subsequent Visit Objects to an earlier or later time (or both) to allow the Drag and Dropped Visit to fit in the day's lineup. Overlapping Visits may or may not be permitted. Re-ordering Visits when a Map It function is “ON”, may automatically recalculate/display revised Routes.

Pressing long and releasing a Visit Object, may display the Edit-Mode Highlight and Elements. When in Edit Mode, the user may edit the Start or Stop-Time of the Visit. The Start or Stop Time dot element may be pressed and Held at the Top or Bottom of the Box Element, and then dragged Up/Down to Decrease or Increase the Start or End-Stop Time of the Visit respectively.

Adjusting the Stop-Time of a Visit with Subsequent Visits after it, may re-schedule all following Visit Time Slots while keeping intact the Travel-Time Between them. Default Behaviors and corresponding Rules may vary depending on a specific use case. For example, it may be desired to apply different behavioral Rules for Completed Visits in the past, as opposed to Open Visits in the future.

Embodiments allow selecting Days in the Here/Now, Past, and Future via the List view. In particular, the List view allows users to select a days with the corresponding Map views in the past, Current Here/Now, and Future. As a highly usable optimized control, Drag, Swipe, and TAP gestures are interchangeably available for manipulating the List Control.

List Drag Gestures may be used on a surface of the List or Header. As shown in FIGS. 2D-E, dragging the List Surface towards the left may display the next Day to the right of the currently displayed Day. Once the Transition has fully “settled” on the next day, the Map View Transition occurs, and the corresponding Visit PIN locations are displayed. The colored “Today” Highlight indication in the Header Date is persistently displayed, but may be in a “faded” visual state when not in the Center Focused view.

To provide an affordance to aid user recognition of display of a day other than “Today”, the List Control Background may incorporate a subtle colored tint on days in the past or future while the Here/Now Today's List is presented with a light Gray background.

The displayed Time Grid (Left edge of List according to scrolled position) may be persistently retained when moving through day selections, but may be automatically scrolled to fully display the Relevant Visits. The Drag Gesture may be used as described above to display Days in the past (prior to the day in view) by Dragging the List Surface towards the Right.

Even though the Header and List are located adjacent to each other—these may be separate components that move at different rates during Drag or Swipe motions. This may be due to the shorter distance between the three displayed dates on the Header, as compared to the distance the list must travel to be in full view. Dragging the Header Left/Right can move up to a set number (here 3) of days at a time, thus providing an accelerated selection action as compared to Dragging the List Surface.

Swipe Gestures may be interchangeably utilized in the same manner as the Drag Gestures described above. Swiping on the List Surface may only move one day maximum no matter the amount of inertia used. However, Swiping on the Header with slow-to-fast inertia levels can variably move the display from one up to a maximum number of days (here 6) at a time, thus providing the ability for rapid, single action selection of a day further in the future or past than is possible from swiping the List Surface.

A TAP Gesture may be made available on the List Header. Tapping on a day before or after the currently displayed “Center Position” day, will select that day. Upon TAPPING on a day (other than the Here/Now Current Day), will display a Blue Highlight on that day and the Header and List will Slide the selected day to the Center Select position. Once settled in the center position, the blue highlight fades away until completely removed.

If the Here/Now “Faded” color Highlighted day is located to the left or right of the center position, when TAPPED the Highlight is immediately displayed in a non-faded state and the Header and List will Slide to the Center Select position with the persistent color Highlight remaining displayed. As the automated List Slide animation is occurring, the List Time-Grid View may automatically “scroll” to display the user relevant Visit Objects for that newly selected day.

Embodiments of UIs may provide search box controls and returned Time-Smart results lists as shown in FIGS. 2H-I. Embodiments of UIs may exhibit one or more of the following:
common elements are deployed;
results are returned only including visits;
selections may be persistently synchronized with the list and corresponding MAP display, so selecting a Search List Item will invoke Automated TimeBar and Map Transitions that move to the Day, Time and Map location of the selected Visit, including the display of the corresponding Small Location Bubble;
returning to the Search List after a Visit item has been selected, may provide a contextual Navigation Affordance (Highlight) on the last Selected Search List line-item that remains displayed in the Background;
if after selecting a Search List Item, the user changes the day or selects another Visit Location on the MAP, the interface then re-opens the Search List, the last-selected Contextual Navigation Affordance (Highlight) is removed from the Search List.

By default, the current Day and corresponding Map may be persistently displayed upon initial presentation of the Landing screen. Presenting Routes on a MAP view may be provided by the interface. More than simply displaying static Route-Lines on a MAP, interfaces may animate both the MAP view and Route lines in concert to deliver an intuitive experience enhancing a user's ability to visualize and consume the many Route attributes that occur over time.

Route requirements as deployed by Pattern Attributes may vary depending a use case. In some embodiments, routes may be of secondary importance to users, and so a route may be displayed when invoked by a user. Route and Map Animations according to time and location may be used as a Transition as opposed to a working function.

Displaying route information between Completed Visit Locations on a Here/Now screens view may or may not be useful. The option to Pause and resume a Route Animation Transition may also be provided.

The inspection Use Case for knowing where a user is to be “next” may be desirable (as opposed to knowing the lineup throughout the day). A contextual visual focus on “next” Visits in a Route may be provided.

A Map It Function may be used. An ON/OFF Button may be used as an implementation of the Map It Button Control and function. Primarily as an “ON/OFF” Button Control, the MAP Route is either selected “ON” (displayed) or “Off” (No Route Lines Drawn); so when “ON” the Button remains highlighted, and “OFF” not a highlighted button state.

Additionally, as a Transition Animation, the Route lines may not just appear, but may be progressively rendered (drawn) in concert with the List TimeBar animation and corresponding time indications as it moves downward through Time in the List. This provides the user with affordances and correlation with scheduled Visits and time-between travel as the Route is being drawn live. Once the Route rendering Animation has completed, the Route remains displayed until the user taps the Map It button again to turn “OFF” the Route Display and remove the Button highlight.

Tapping on the Map It Button during the Animation, may “Pause” the Route rendering at the position when the button was tapped, and the text “Paused” will be displayed inside the button in a Flashing on/off manner. Tapping on the Flashing Pause Button may change the Button Label back to a highlighted “Map It” and Resume the Animation till complete.

Embodiments of user interfaces may provide contextual relevant views and transitions. Threaded throughout the interface may be the Attribute for displaying only relevant data and visualizations in default views. Embodiments may make use of this principle to minimize the need for the user to make unnecessary navigations and selections to view what's important according to the use case and user profile. Contextual relevant views and transitions in various device orientations may allow interfaces to enhance user productivity at the same time optimizing intuitive user interaction.

Embodiments may employ Default View Rules. Default List Views may include Here/Now Indications including but not limited to:
showing the Here/Now TimeBar or Time/Day List Header when initially displaying a TimeSmart List screen or popup;
showing relevant Display of Visits;
in the Here/Now Default Screen, displaying the Current Visit at the Top of the List with the Visit Box element in full view;
in a Past or Future day Default Screen, display the 1st Visit object at the top of the list.

Embodiments may employ a Time GRID, which can function to:
retain the selected scroll position of the Time-Grid when moving to another day;
after New Day selection has settled, auto-scroll list to display Relevant Visits (above);
the list auto-scroll may simultaneously occur during movement of Time-Grid to another day.

Default MAP Views may be employed when initially displaying a MAP visualization. The view may auto-zoom to allow all Visit/Stops within that Day to be displayed. If the user has manually changed Map Zoom or Pan, the above Default view may automatically be restored upon the following actions: Selecting Here/Now Control; Selecting a Visit Object from the List; Selecting Map It; Selecting another Day; Editing the Order of Visits; or Selecting a Location from the Search List.

Default TimeBar Views and Behaviors may be established as follows. The colored Here/Now TimeBar may not be removed from the Today, Here/Now screen. The Here/Now TimeBar may be displayed in default GeoTime Landing Screen. The Here/Now TimeBar may be displayed in the target screen after invoking the Here/Now Control. The TimeBar may point to (intersect with) the List Object corresponding to a PIN Selection. On the Here/Now default screen, the future TimeBar may emerge from the present TimeBar upon initial selection of a PIN other than the Here/Now PIN as it moves to the target timeposition of the PIN selection. The future TimeBar may be removed when the corresponding Small Bubble from a PIN is dismissed. When selecting various PINs on a Map, the future TimeBar animation may start from the last selected Visit position. Upon selecting a Visit from the Search List, the future TimeBar animation may start from the top of the default List view. If the Search Selection is on a Here/Now day, then the future TimeBar animation may start from the present Here/Now TimeBar.

A user interface may employ transitions and/or animations as follows. PIN-Drop Transition may cause PINs to Drop from the Top of the screen in the order of Visits according to time as they appear and land on target Map locations. The PIN Drop Transition may be presented on the Default Map View (zoom-level) when all PIN can be displayed.

The PIN Drop Transition and Animation may be presented in the following cases: upon Initial launch of the application; when Selecting another Day; after editing the order of Visits; when Selecting Here/Now Control from any day except the current Here/Now day. The PIN Drop Transition may not be displayed when selecting a Visit from the Search List.

An auto-swipe Transition between Days may be accompanied by an Automated Left/Right sliding animation of the List view between days, as would occur by the manual swiping gesture. This may be Presented when the Here/Now selection is from any day other that Current Here/Now day, or selecting s Search Return Item that resides on a different day than is currently displayed in the background behind the Search popup.

Route Animations and Transitions for the table may be associated with the Map It functionality. The present route may be invoked by the user (Map It On/Off). The True North View of the Map may be retained. The Route may be rendered without panning Map in Default View. Route Rendering may be permitted moving forward or backward through time.

Pan Map may be allowed during Route Animation when in a zoom-in state to allow the Route path to be displayed in view. Pan Map may be needed to allow Small PIN Bubbles to be fully displayed on screens and in any orientation.

During and within the Animation Play-Rate (Speed of Simulated Time Movement), the Small PIN Bubble may be displayed according to the duration of the Visit. During and within the Animation Play-Rate (Speed of Simulated Time Movement), the Route-Lines Between Visits may be drawn according to the TimeBar List Animation.

A user may be allowed to dismiss a Route rendering. When Rendering a Route Line, the user's relative position may be at the leading point of the Route Line as it is being drawn according to the TimeBar List Animation. The Location of the PIN Bubbles may be opened/closed as the user position approaches and departs a corresponding Visit location.

On the Current Day, Routes may be rendered from the Current Visit to subsequent future Visits. Routes may not be rendered between Completed Visits in the Current Day. Routes may be completely rendered, and All Visits for Past and Future Days, when invoked by user.

When displaying a Route via Map It Button, Run the Map It rendering animation as an entry Transition, and then leave the route statically displayed until the user dismisses it (Turns-Off Map It). The Route may be dismissed when changing a day selection. Map Zoom may be allowed during an Animation. The Map It Animation may be paused and resumed. The Default View may be used when initially displaying and animating a Route.

When Map it is ON, the interface may Re-Calculate and re-draw a Route each time after the user has changed the order of Visits. According to certain embodiments, this may be done by dragging the list visit objects. In certain embodiments, the order of visits may be changed via the PIN on the map.

Embodiments of interfaces may exhibit behaviors that collectively deliver an intuitive, responsive, user experience. List and MAP selections, navigations, and edits may be readily and interchangeably available to the user in default and other views.

The Here/Now control may be invoked as follows. Invoking Here/Now will immediately Navigate the UI, including animated visuals and automated scrolling to the current Day, Time, Status, and Relevant Visit List and Map view. In particular, this functionality allows one touch return to Current Here/Now Day and Default View”

A Here/Now Transition from Past/Future may be accomplished through one or more of the following:
moving to a distant day in the past or present;
scrolling the List to a Top or Bottom most position; or
tap on a PIN to open Small Bubble;
   and then invoking Here/Now.

Here/now may be invoked by auto-scrolling:
view on the Current Day;
scroll the List to a Top or Bottom most position (Gold Here/Now TimeBar not-in-view);
pan the MAP to an entirely different map view;
   and then invoking Here/Now.

Here/now may be invoked by change orientations. In particular, as navigations and Here/Now Selections above are being performed the device may be rotated between orientations to observe elegance of the programmed behaviors and automated Transitions and Views for both List and Map presentations.

The Selection and Drill-Down experience for MAP Pins may differ according to native expectations of those devices and the different use cases. Additionally, the implementations of the TimeBar controls may be different between these two device platforms.

One MAP PIN Selection Use Case for the tablet may be to Inspect Visit Location and Customer information. MAP PIN Selection Transitions may be as observed as follows.
(1) On any View, quickly Select various PINs;
(2) Do this for every PIN displayed, not necessarily in order;
(3) On a Small Bubble, TAP in little (i) icon to open large Bubble;
(4) Tap on another PIN on the MAP (Closes Large Bubble and simultaneously Displays PIN Small Bubble).

MAP PIN Drill-Down may be accomplished as follows:
(1) Select a MAP PIN;
(2) On Small Bubble Select Blue Disclosure Icon to view Detail;
(3) Select “My Schedule” to Return to GeoTime View;

the Small Bubble and TimeBar indication remains displayed as a Navigation Affordance.

The Visit Object may be selected from TimeSmart List for the tablet, and “Detail Inspection of Visit Information” obtained, by the following:
(1) on any Screen, Tap on any Visit Object (Box) to open and inspect the Large Bubble information;
(2) From the Large Bubble Tap on Detail Button to navigate to the Detail Screen;
(3) Tap on “My Schedule” Button to return back to the view, with the Selected Visit Object will be indicated in a colored highlighting).

Map It Selection Use Cases for the tablet are as follows. To “Display Route, Play/Pause/Resume Route Animation Transition”, a user may:
On any GeoTime View Tap on Map It Button;
During animation, Tap on Map It Button again to Pause (Button Label Text “Paused” will Flash);
Tap Again on Flashing Button to Resume;
Allow Animation to finish, Route remains displayed (Button Highlight remains displayed to show “ON” State)
Tap again on Map It Button to turn “OFF” Route Display (Button Highlight is removed)

Past or Future Day Relevant Views may be available to provide a Consistent display of Relevant Visit and Map Data in Portrait and Landscape Views, by one or more of the following:
On any Day GeoTime view, Invoke Map It to display Route;
Re-arrange Visit lineup and Order via Drag and Drop;
Spread-out Visits so all Visit Objects cannot be displayed in List in Portrait;
Increase Durations on a few Visits;
Scroll List Up/Down to view a Visit of interest—Tap on its Location PIN to open Small Bubble;
Turn to Landscape and Back again to view consistent display of relevant Visits in view.

Smart Phone

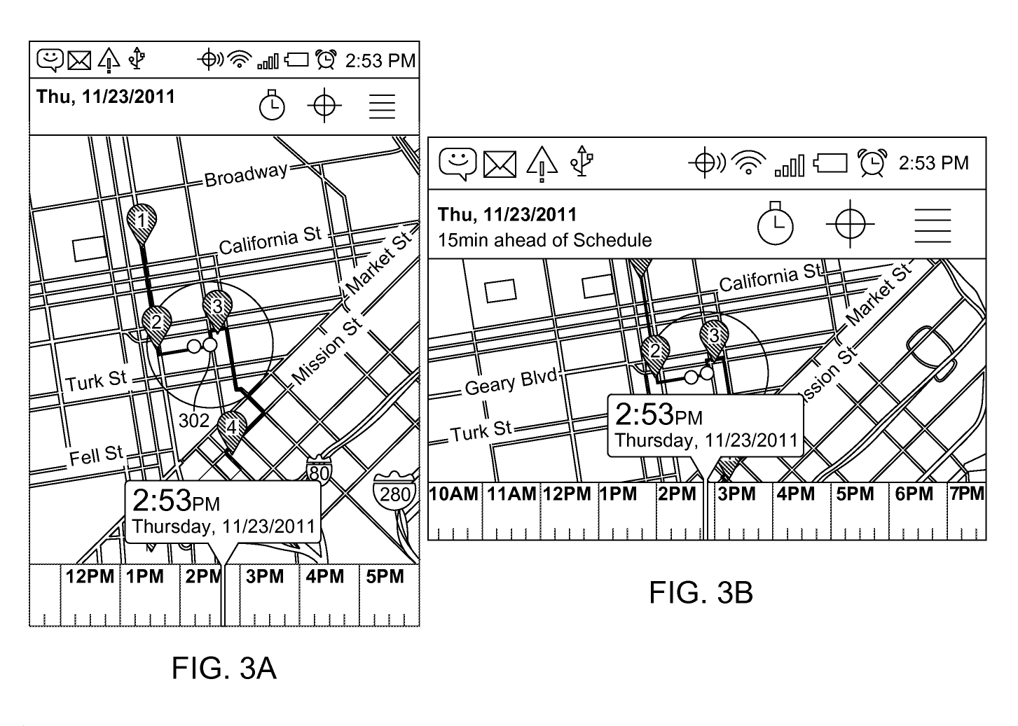

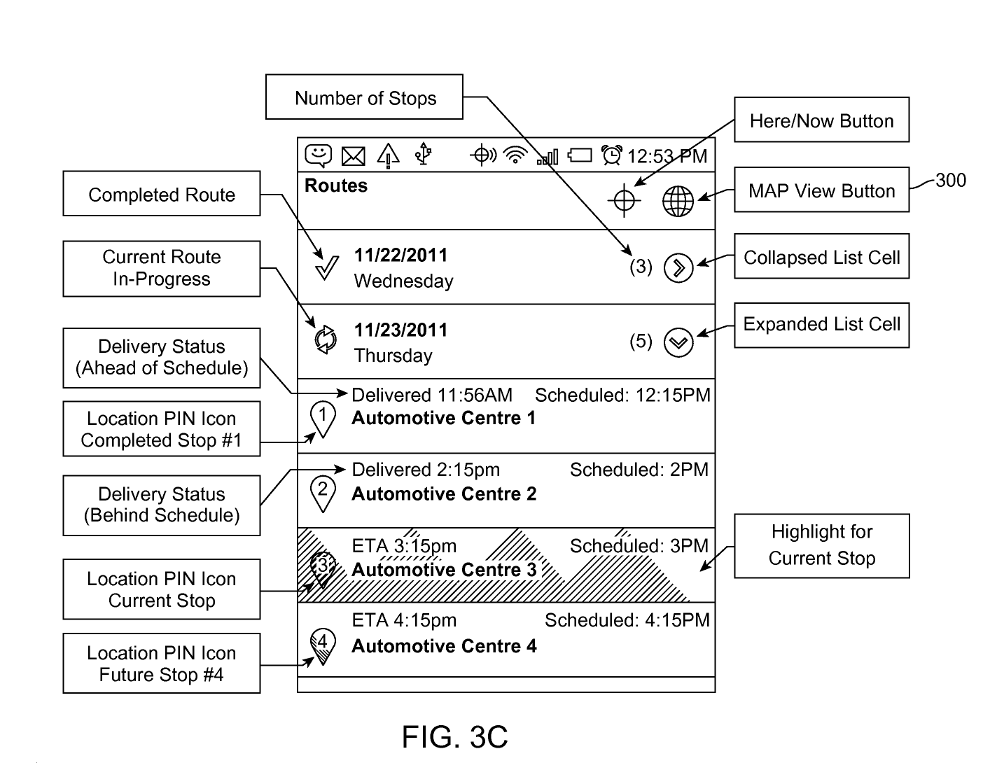

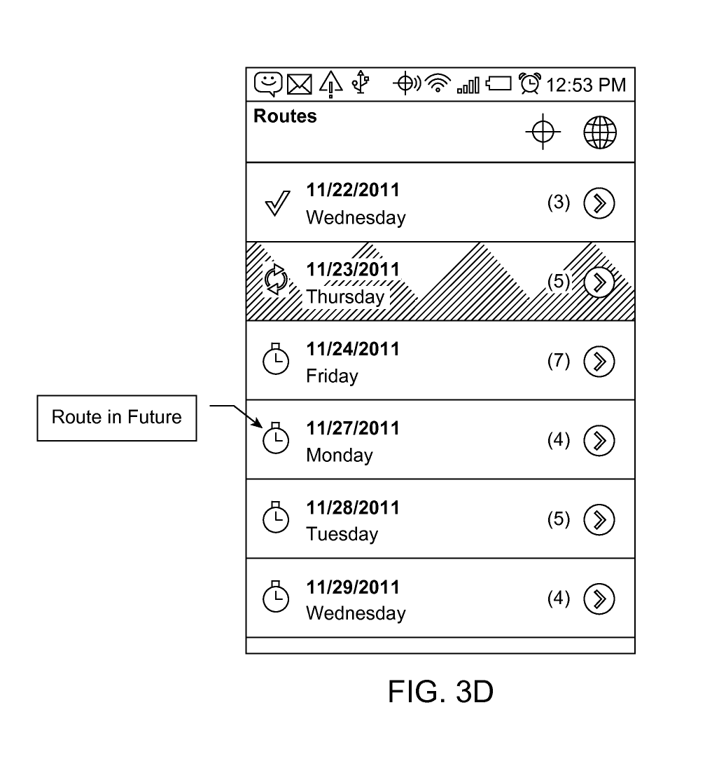

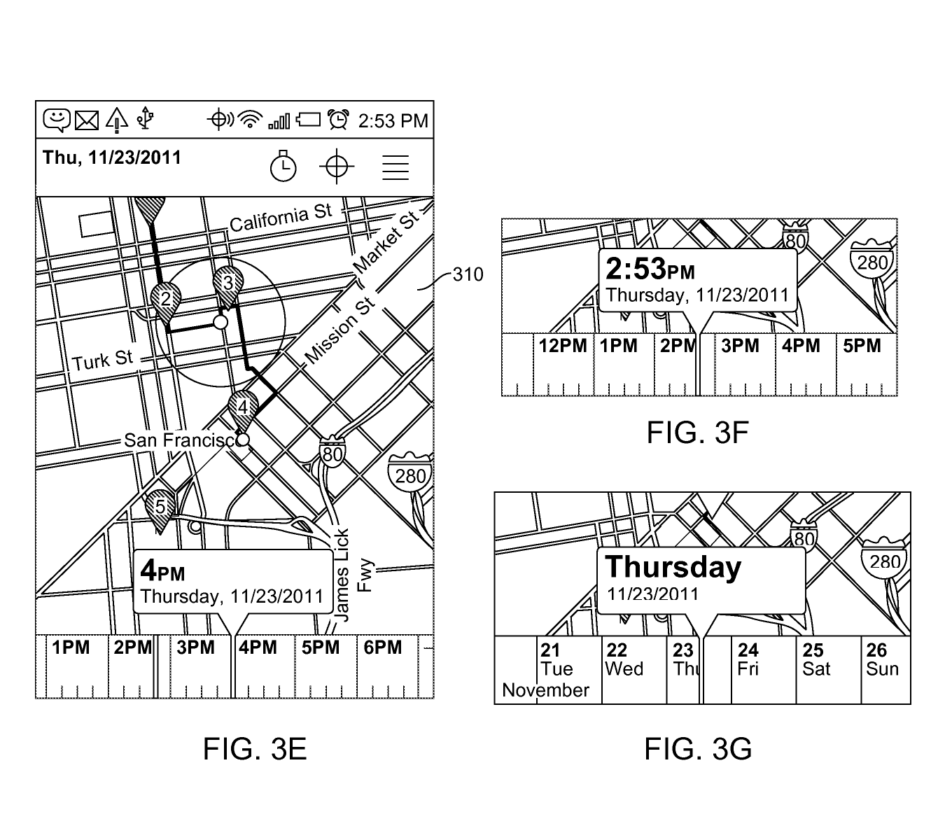

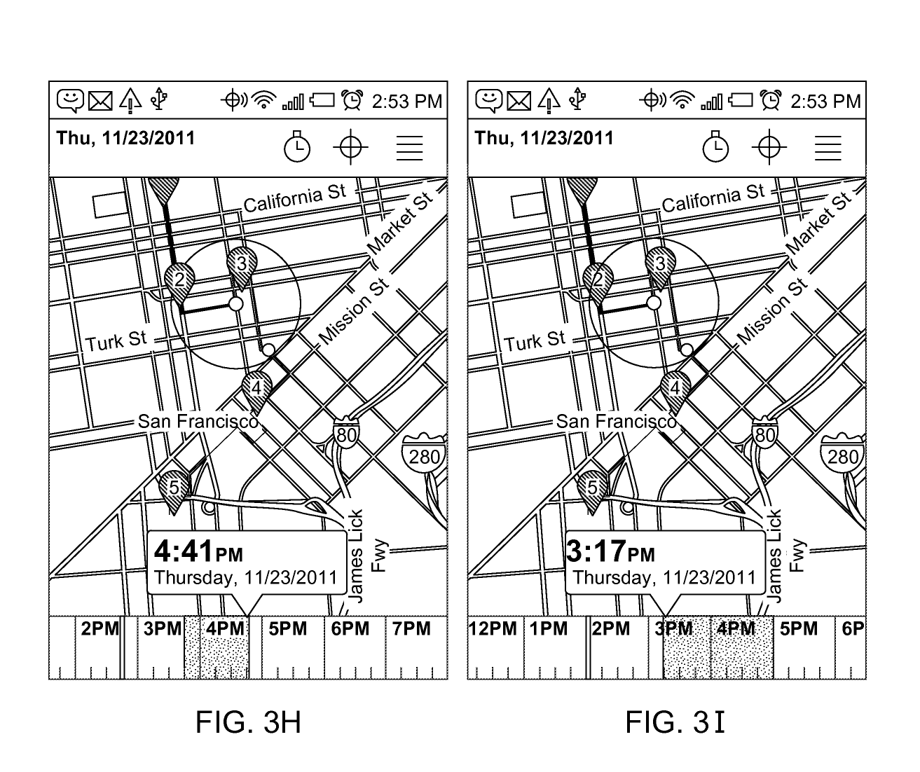

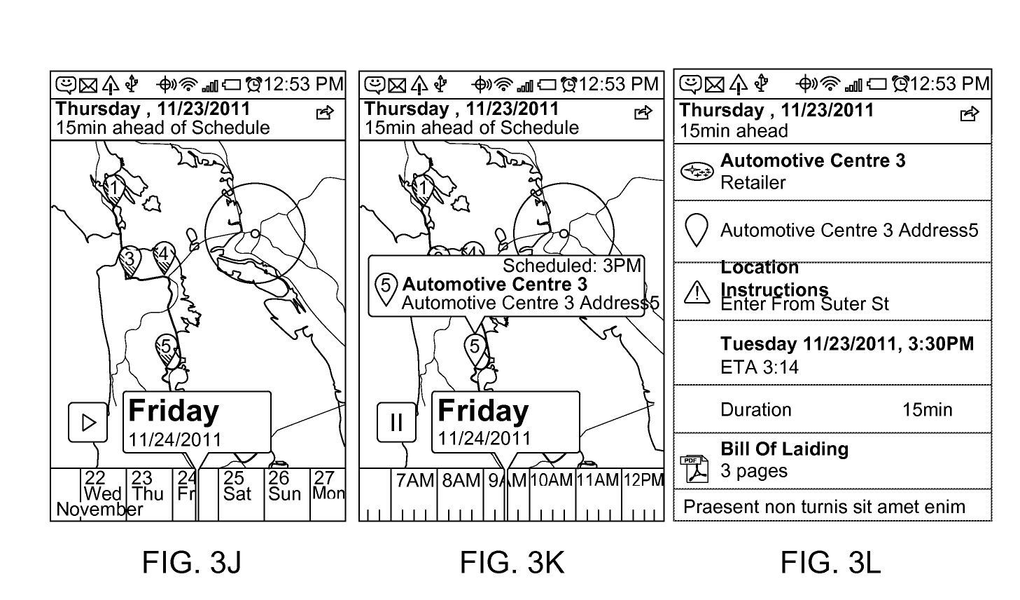

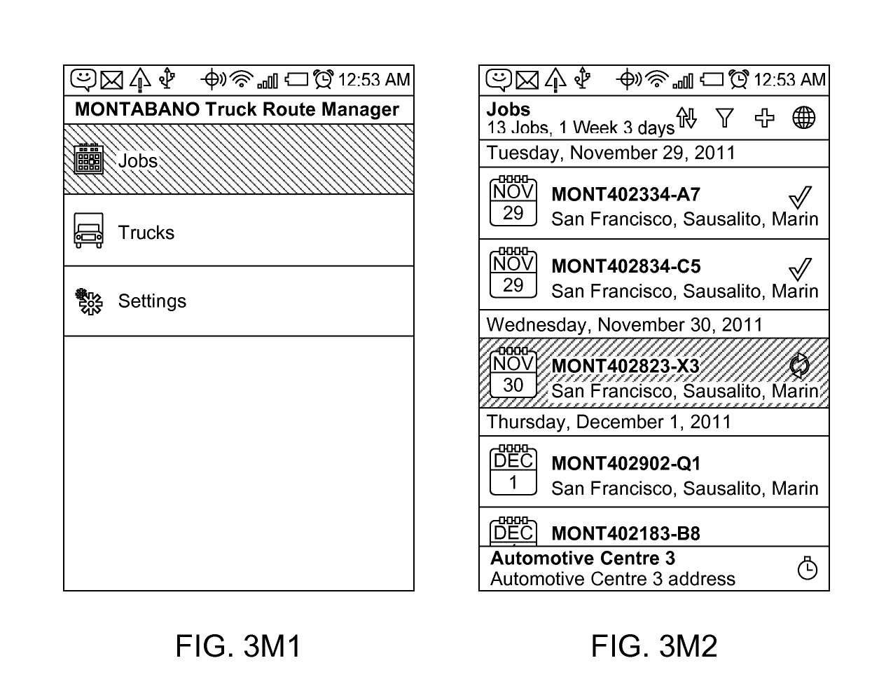

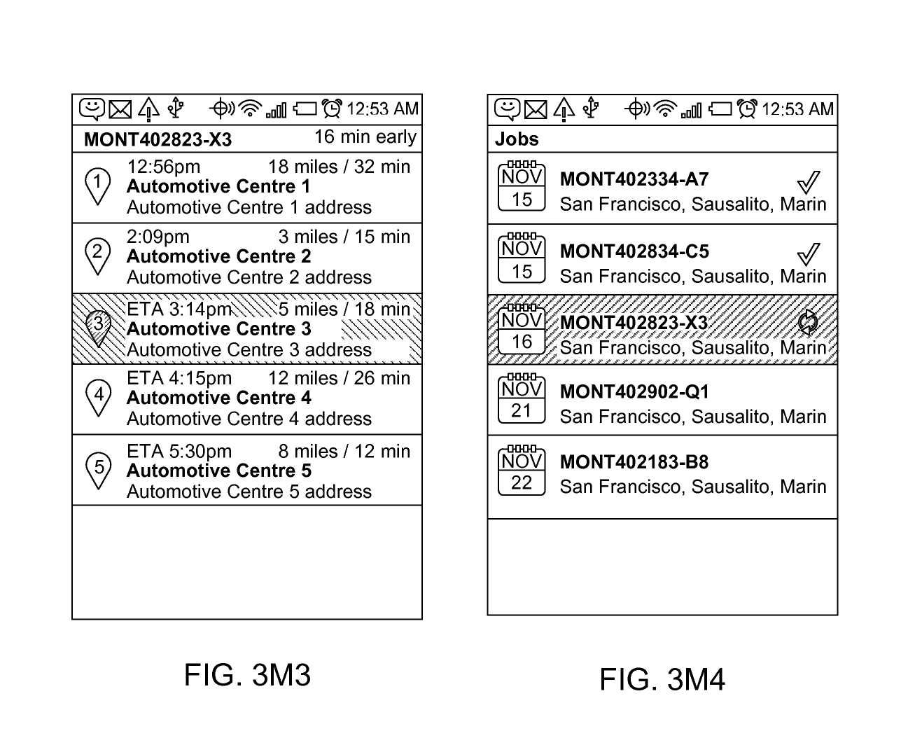

Given the small size of the smart phone device, it may not be possible to comfortably display both the list and map views on a smart phone screen. Accordingly, embodiments may deploy a custom timebar control overlaid on the MAP, as is shown in the portrait and landscaped views of FIGS. 3A-B, respectively.

This timebar may provide the user with time according to map indications, selections and Route. The list view of FIG. 3C may be deployed in a separate but readily accessible screen, via a Dynamic View Button 300 for one-touch switching/toggling between MAP and list views, while at the same time keeping intact synchronized contextual affordances and interoperability between Map and list views.

The UI Attributes and screen examples for the smartphone context are illustrated with reference to a specific travel management use case involving Daily Truck Pickups and Deliveries (“Stops”) along a persistently displayed Route. In this scenario, the user is mostly interested in Route and Delivery/Pickup locations and information (Pickup/Delivery Schedule and material information, loading dock assignments, etc.). Routes and Stops may be predefined by a dispatcher (from the system backend) so functionality for changing these features may not be as important.

Embodiments also work with Routes that span over multiple days or weeks, in use cases for cross-country routes and stops that take days and weeks to complete. This can be accomplished by a simple contextual re-organization of List and Map views to cover larger geographical areas and time durations. This is discussed further below in the smartphone environment in connection with the Job concept, but is not limited to that particular platform.

Attribute examples for this smartphone implementation are discussed in connection with FIGS. 3A-3L. The interface again includes a timebar with Real-Time Running Clock and Map Location Indications. The TimeBar Attribute is a custom control that is overlaid on top of the MAP view.

The colored time indication persistently represents the current time as the TimeBar itself moves forward in time (towards the left) according to the Real-Time Clock. It indicates/displays real clock time in both in a linear graphical method in the timebar itself and in numeric digits in the same-colored Bubble. The colon (:) between the numeric Hour and Minute display Flashes On/Off every 500 ms to communicate a Real-Time “Running” Clock.

The differently-colored DOT on the Map Route represents the “Calculated” position according to the Stop schedule and as indicated by the current Real-Time in the TimeBar. The colored dot 302 represents the Actual GPS location (detailed later). FIGS. 3A-B show portrait and landscape examples of a Here/Now Landing Screen and TimeBar (2:53PM) and corresponding Map indications.

The screen may show GPS and Calculated Position Indications. A GPS Map indication epitomizes the context of Real-Time “Here/Now” on a MAP. The GPS colored Dot represents the Real Position of the mobile user via GPS, and the differently colored DOT on the Map Route represents the “Calculated” position according to the Route schedule at the exact time indicated by the current Real-Time in the TimeBar. The colored GPS DOT time flashes On/Off every 500 ms to demonstrate its Real-Time calculating attribute and pairing with the TimeBar. A user's GPS position on or near a Location PIN can functionally interact with status indications and even effect or automatically change Visit schedule and/or duration times.

In this particular embodiment, the “Calculated” colored Dot is flashed to show the running process of time calculation. The current time/location GPS Dot is left non-blinking. The current GPS Dot, however, may have the added affordance of a transparent radial graphic indication, to further differentiate between Calculated and GPS location indications.

Embodiments of the interface can include location PINs with Status and Visit Order Indications. The default landing screen utilizes “PIN” Icons to locate a Stop on the MAP and in the List view. PIN icons provide affordances for showing the Status of the Visit (Color) and the sequential order of Visits (Number or Letter). The Number indications are used to programmatically animate (draw) Route simulations in order between each Stop according the TimeBar control's display of corresponding time.

One or more status “States” may be associated with a PIN as shown by the color assignment to the PIN Icon. Color and Number coded Location PIN icons corresponding to each “Stop” location and are persistently used in both MAP and List views to further contextually pair these elements. For example, a green color may be used to indicate past stops that have already happened in the past, a gold color may be used to persistently indicate a current Stop Location, and a red color can be used to indicate stops in the future.

Embodiments of interfaces may include a route line as shown in FIG. 3E. If the current time happens to be within today's route, the Route Line will be colored in one manner to indicate past destinations, and colored differently to indicate future destinations. For example, routes displayed in a day from the past will be Green while Routes in future days will be displayed Red.

According to certain embodiments, only the Current “Here/Now” Day and View may be a standard view of the Map. In a past or future Day or Time, the Map may incorporate a translucent colored overlay 310 as shown in FIG. 3E. This overlay as an unobtrusive affordance to indicate when the Map view is in a simulated (Non-Real-Time) view, or in the Real-Time Here and Now. Note this translucent overly would not be colored the here/now color, but that color could be used in UI elements to persistently indicate the current time, Stop, or location in both MAP and TimeSmart List Screen views. The color of the translucent overlay could also be used in elements relating to simulated times (Past or Future).

The timebar could be controlled as follows. The timebar could be retracted and extended by tapping on the TimeBar “Clock-Tab” (when retracted) to extend the TimeBar control, and tapping on the TimeBar “Bubble” Retracts the control. In Both Control States (Extended and Retracted), the indicated Time or Day may continue to be displayed, depending on the currently selected Day or Time Scale. Additionally, when the timebar is extended, selecting the Back Key (in devices that incorporate this control) can retract the control, and selecting the Back Key again (when the control is retracted) can exit the application and display the device Home Screen.

As shown in FIGS. 3F-G, a dynamic Action Bar Button can provide one-touch toggle selection of Time or Day scales. A Time Scale Button function can be achieved by tapping on the Clock Button to change the TimeBar Scale to the “Time” Scale at the same time changing the Button to the “Day” Scale in a ready state for toggling between the two scales. Tapping on the DAY Scale Button may change the TimeBar Scale to the “Day” Scale at the same time change the Button to the “Time” Scale in a ready state for toggling between the two scales.

As shown in FIGS. 3H-I, the TimeBar may be operated to Display Route Animations and provide Route and Stop information and experiences. The TimeBar control is the mechanism by which users may manipulate and view animated routes with corresponding Stops according to time. This allows them to inspect their pickup and delivery schedule and street route between stops via simple gesture operations of the TimeBar as described below.

In the Here/Now default day Map screen (in Time Scale), dragging the Time Slider to advance into a future or past time, and releasing the touch control will set the Route Animation in motion. The TimeBar deploys multiple interoperable gestures and affordances to deliver an optimized Time/Map selection representing a fluid experience.

Dragging the TimeBar to future or past times, and “releasing” the control, will set the Time Animation in motion in that direction (Forward or Reverse) from the current selected Time Position. A “Window Shade” retractable highlight may be displayed when dragging, and upon releasing touch on the control, will set this highlight in motion as depicted by the “Time” displayed in the TimeBar Bubble. The animation will run as the Window Shade highlight retracts until the target time initially set by the Dragging gesture is reached.

Navigation may also be achieved by tapping on an Alternate Time in the TimeBar. In addition to Drag and swipe gestures, the user may interchangeably “Tap” on a Time past present, or future, and the TimeBar will automatically move to that Tapped position.

Integrating the Dimension of Time into Lists may be accomplished numerous ways. Generally, creating a list view may be accomplished by applying a Real-Time Clock function, Object Time/Date Indications and user selections alongside of contextual affordances and behaviors that persistently pair (synchronize) Map and List presentations.

Elements common to various UI's according to embodiments, may include but are not limited to:
Time Indications For Each Location, including but not limited to a Time Grid, Time Displayed in numeric values, and a Date/Day/Month/Year;
Here/Now—Clear Indication for Here/Now Current Day, Time, and Location;
Location PINs—Location PIN with Status and Route Order Affordances;
Location Address—Some level of displaying a physical location name and/or address;
Ability for User Selection—List Selection may be reflected on the MAP View even if the MAP is not shown on the same screen as the list;
Running Clock—The List Views and Affordances for Time and Status Automatically and Continuously Update According to the Real-Time Clock.

As indicated above, an interface for a smartphone platform includes a list view. In certain embodiments for example as shown in FIG. 3C, the smartphone UI may deploy a completely native, non-custom list control. Using an Expand/Collapse List, Calendar Days (Daily Routes) may be listed in an ascending order from Top-to-Bottom. Selecting a Date list cell expands the corresponding cell to display the Stops (Locations) according to the Route order and times. Selecting another List Cell Date automatically closes (collapses) an Expanded cell at the same time opening the newly selected Date cell.

Additionally the user may manually expand and collapse a cell by tapping on the Arrow Icons. Only one Cell may be expanded at any time. Selecting a Stop Location in an Expanded Date cell will transition to the corresponding Detail screen of the selected Stop. The Back Key may be used to return List View, and the Stop List Cell selected may be highlighted to provide a Navigation Affordance for the user's previous selection of the Detail view.

As discussed throughout, one characteristic feature of user interface embodiments is their synchronization between List and MAP Views. In smartphone embodiments, list and MAP views may be persistently synchronized, even though the MAP and List are on separate screens. And so, making a Time or Location selection on the Map will be displayed when navigating to the List, and visa-versa.

When selecting a MAP Location PIN in MAP view, then navigating to List View, the list cell corresponding to the MAP Day and PIN will automatically be expanded and Highlighted without the need for the user to make any list actions whatsoever.

As shown in FIG. 3C, Dynamic Contextual Button located in the Top Action Bar Header may be used to navigate between List and MAP synchronously with a single TAP action. Additionally, Contextual Navigation Affordances (List Highlight and MAP PIN Bubble) may be persistently displayed to Pair selections between List and MAP.

For various Locations, PINs with Status Color Code on MAP may be persistently synchronized between MAP and List views, including the Route Order as indicated by the Stop Number inside each PIN. Tapping on the List View Button may Transition to the List View and automatically change the Map View Button. Tapping on the Map View Button may Transition to the Map View and automatically change to the List View Button.

A second, Non-Synchronous Method on the Smartphone may be to use the Back Key to Navigate from a List View to the MAP. In this use case if the user navigates the list to another day, selects a stop, then returns to the List and MAP via the Back Key, according to a native default behavior of devices that incorporate back key controls, the MAP View displayed may be whatever was in last view before selecting the List.

According to various embodiments, the list view for the smartphone platform may utilize one or more of text color, icons, and highlighting to indicate States, Selections and Stop Schedule Attributes.

To Apply a Real-Time running clock experience to a native list control on a smartphone, the list may be predisposed to programmatically open (expand) the current day's cell, and highlight the Current Stop with the Here/Now color. As time progresses, the Here/Now Highlight and PIN icon Status may be automatically changed (moving forward in time) to reflect the actual TimeSmart Status of the Route and Stops.

In the List View, the user may scroll/navigate to another Day and Route Stop and View Details. Then, when invoking the Here/Now control, the List will automatically scroll to the Current Day and Scheduled Stop in an “Auto-Scroll” transition animation.

The route Attributes for a UI of a smartphone embodiment, may exhibit one or more of the following properties:
routes may be of importance to users, and so routes may be persistently displayed by default on screen views;
route animations according to time, may be of importance to inspect street directions and corresponding schedule assignments by a dispatcher; embodiments may thus persistently allow Route Animations to occur when making timebar selections and when invoked by user in Day Scale;
an inspection Use Case for knowing where a user is scheduled to be, at what time, may involve the display Route Animation and user position along a Route when selecting Times on the TimeBar Control;
a route Animation may simulate GPS location movement, and Pan the Map to show GPS location movement along a Route.

In smartphone embodiments, route animation may be used as an inspect tool. Users may move forward and backward along the Route while zooming-in to obtain street map and Stop details, etc.

Several methods may be used to initiate Route Animations. One is via operation of the TimeBar Control. Another method is on a Day Scale, to invoke the Play Button to Start/Pause/Resume the Route Animation. This is now shown and described in connection with FIGS. 3J-K.

Specifically, when in the Day Scale, the PLAY Button will be displayed over the Map Screen. Invoking the PLAY changes the Button to PAUSE, changes the Scale to Time Scale, and starts the Route Animation according to displayed Times. After the Route Animation has completed, the Scale is automatically changed back to the Day Scale, and the Play Route Animation control is again available for replay.

During the Route Animation, the user may effect one or more of the following:
Pause/Resume the Route Animation;
Make Map Zoom and Pan Adjustments via Pinch and Drag Gestures;
Select Alternate Times via Tap or Drag When PAUSED to forward/revere Route Animation;
Open/Close and Select Location Bubbles to view Detail Screen;
Tap on Bubbles to view corresponding Detail Screen (shown in FIG. 3L) and then return to animation;
Tap on DAY Scale control to re-set the Animation;
Move to a List View and Back to Running Map Animation via the Action Bar List/Map View Button.

In various embodiments, route visualizations and Animations on a smartphone platform may occur according to one or more of the following principles:
Retain True North View of the Map at all times;
Always show the relative position of the user as a stationary position in the Center of Screen during Route Animation;
Pan the Map, Not the User's relative position;
animate a Route according to Scheduled and user Selected Times;
Pan Map to enable a selected MAP PIN Bubble to be fully displayed in all orientations;
Allow a user to select an Open Location PIN Bubble during Route Animation or Pause, and move to the corresponding Detail Screen (FIG. 3L). Returning to Map View automatically resumes Animation.
allow the user to “reverse” or “forward” through a Route via TimeBar operation.
display routes in all Map Views for all days.
allow the user to initiate Playback, Pause, and Resume of a complete Route animation (all Stops) on any Day.
reset to Default View when initiating a Route Animation.
allow sticky zoom during animation Play/Pause/Resume.
allow the user to switch to List View during Animation. Upon switching to list, the List View is to be synchronized to the location and Route Map and Day from the Map view.
upon Switching back to Map Animation from List View, the Animation is to automatically resume.

Embodiments may allow Here/Now Use Case Selections with One-Touch Return to Current Here/Now Day and Default View. In the context of a route selection, one example is to perform the following:
(1) In Time-Scale, drag/swipe the TimeBar to a time in the future;
(2) Allow the Route Animation to complete; and then
(3) Invoke Here/Now

In a Day-Scale context, an example of here/Now Selection is to:
(1) Change from Time to Day Scale via the Header Button;
(2) Select (Swipe, Drag or Tap)a Day in the past or future a Day;
(3) Pan the Map;
(4) Select Here/Now Button (Compass icon in Action Bar Header).

An example of here/Now Selection from the TimeSmart List View is as follows:
(1) From any Map screen, Go to List View;
(2) Scroll List to a distant day in past or future;
(3) Expand that Day;
(4) Select a Stop to go to detail;
(5) Select Android Back key to return to List
(6) Invoke the Here/Now Button in Top Header

A number of use cases are possible for MAP PIN Selection in a smartphone context to Inspect Stop Location and Delivery/Pickup information. For example, MAP PIN Selection Transitions may be as follows:
(1) On Default or any Day MAP View, quickly Select various PINs;
(2) Zoom MAP in and out to explore different PIN Selection view behaviors

An example of MAP PIN Drill-Down and List Synchronization is as follows:
(1) Select a MAP PIN from any Day;
(2) TAP on Bubble to view detail;
(3) Invoke Back Key to return to MAP (Bubble remains open);
(4) Switch to List View (MAP PIN Stop Selection is indicated (Highlighted) in the List);
(5) Select Highlighted Stop to go to Detail;
(6) Invoke Back Key to return to List;
(7) Switch to MAP View;
(8) The Context of the user's navigations during PIN Drill-downs and View Changes remains constant.

As mentioned above, various embodiments of interfaces may also work with Routes spanning multiple days or weeks, in use cases for cross-country routes and stops that take days and weeks to complete. This can be accomplished by a simple contextual re-organization of List and Map views as “Jobs”, covering larger geographical areas.

For example, FIG. 3M1 shows a screen shot of a list view allowing a user to select a Job. FIG. 3M2 shows a screen shot of Jobs, including a job having an incidence on the current day/time (shown hatched). FIG. 3M3 shows that selecting this Job can produce a detailed list view of that Job. FIG. 3M4 shows that the user can also move in time through the list view to identify a prior incidence of that Job on an earlier date.

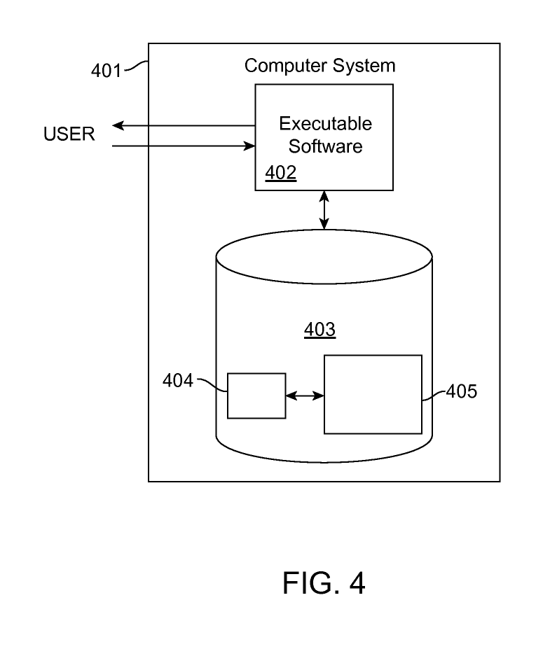

FIG. 4 illustrates hardware of a special purpose computing machine configured to provide a user interface according to an embodiment. In particular, computer system 400 comprises a processor 402 that is in electronic communication with a non-transitory computer-readable storage medium 403. This computer-readable storage medium has stored thereon code 405 corresponding to a view engine. Code 404 corresponds to geographic and/or temporal information. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

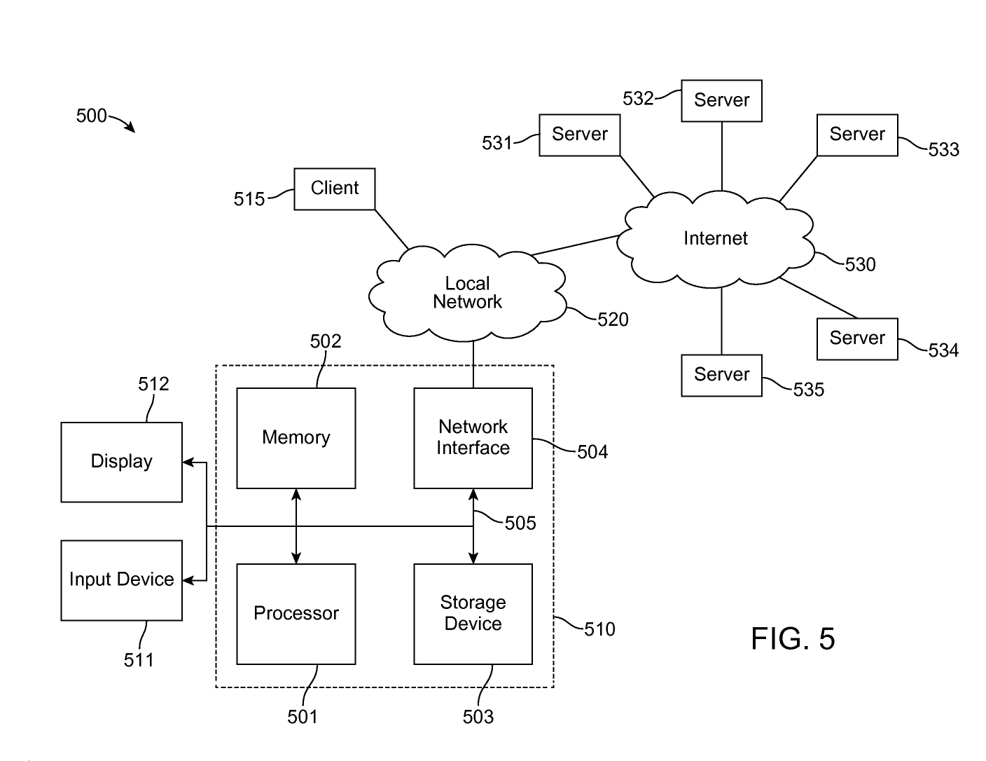

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 is coupled to bus 505 for communicating information and command selections from the user to processor 501. Examples of input devices include but are not limited to a keyboard and/or mouse, as well as any other man machine interface (MMI) including but not limited to a touch-screen, a trackball, device-specific function keys, a centrifugal sensor, a camera, voice recognition and device generated speech, and others. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line or wireless terrestrial communication network, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information, including messages or other interface actions, through the network interface 504 across a local network 520, an Intranet, or the Internet 530. For a local network, computer system 510 may communicate with a plurality of other computer machines, such as server 515. Accordingly, computer system 510 and server computer systems represented by server 515 may form a cloud computing network, which may be programmed with processes described herein. In the Internet example, software components or services may reside on multiple different computer systems 510 or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

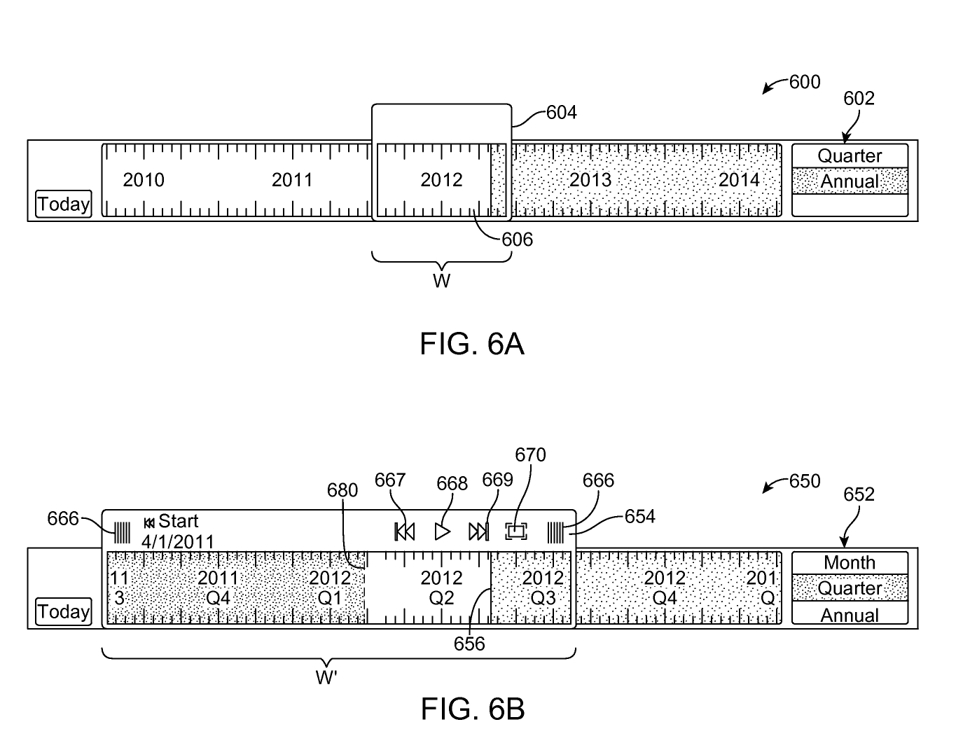

The above description illustrates various embodiments along with examples of how aspects may be implemented. The above examples and embodiments should not be deemed to be the only embodiments. For example, FIGS. 6A-B show different embodiments of a timebar element which may be employed by a user to provide the input of temporal data to an interface of either a tablet or smart phone platform.

In particular, FIG. 6A shows an embodiment of a timebar element including a stationary centered “lens” portion with the timebar moveable therein. A menu 602 allows user selection of an appropriate time scale (here, annual). A lens 604 having a width W corresponding to a time increment, is displayed, with the current time shown as a gold line 606. Time to the right of the line is colored (here shown with hatching) to indicate its future nature. By selecting and dragging the bar within the lens, the user can provide an input of temporal data, with the corresponding display of other (geographic) data on the screen being synchronized thereto.

FIG. 6B shows a different timebar embodiment which may be employed by a user to provide the input of temporal data to an interface of either a tablet or smart phone platform. According to this “movie” embodiment, a menu 652 of the timebar element 650 again allows user selection of an appropriate time scale (here, quarterly).

This embodiment of a timebar features a frame portion 654 having a width W′ that is displayed, with the current time shown as a gold line 656. Time to the right of the line is colored (here shown with hatching) to indicate its future nature. The frame includes sizing bars 666, the clicking and dragging of which allow the user to adjust the width of the frame portion.

The frame also includes rewind control 667, play/pause control 668, and fast forward control 669. Selection of the appropriate control can cause the cursor 680 of the frame to move in the corresponding temporal direction within the frame, resulting in appropriate display of data synchronized to the specific time indicated by the location of the cursor within the frame.

The frame further includes a full screen control 670. Manipulation of these controls by the user renders the interface particularly amenable to the display of data in animated form.

Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing an engine to receive temporal data from a source of time information;
causing the engine to receive geographic data from a source of geographic information;
causing the engine to provide an interface comprising a map view synchronized with a list view according to a time; and
causing the engine to change the interface according to a user input, such that synchronization between the map view and the list view is maintained.

2. A method as in claim 1 wherein the user input is provided to a timebar.

3. A method as in claim 2 wherein the user input comprises interacting with the timebar moveable within a lens portion.

4. A method as in claim 2 wherein the user input comprises interacting with the timebar comprising a playable frame portion.

5. A method as in claim 1 wherein the user input comprises a current location according to a global positioning system (GPS) signal, or comprises a past, present, or future location.

6. A method as in claim 1 wherein the user input comprises a current time according to pervasive time signal, or comprises a user-selected past, present, or future time.

7. A method as in claim 1 wherein the time is indicated by an affordance comprising color.

8. A non-transitory computer readable storage medium embodying a computer program for performing a method, said method comprising:
causing an engine to receive temporal data from a source of time information;
causing the engine to receive geographic data from a source of geographic information;
causing the engine to provide an interface comprising a map view synchronized with a list view according to a time; and
causing the engine to change the interface according to a user input, such that synchronization between the map view and the list view is maintained.

9. A non-transitory computer readable storage medium as in claim 8 wherein the user input is provided to a timebar.

10. A non-transitory computer readable storage medium as in claim 9 wherein the user input comprises interacting with the timebar moveable within a lens portion.

11. A non-transitory computer readable storage medium as in claim 9 wherein the user input comprises interacting with the timebar comprising a playable frame portion.

12. A non-transitory computer readable storage medium as in claim 8 wherein the user input comprises a current location according to a global positioning system (GPS) signal, or comprises a past, present, or future location.

13. A non-transitory computer readable storage medium as in claim 8 wherein the user input comprises a current time according to pervasive time signal, or comprises a user-selected past, present, or future time.

14. A non-transitory computer readable storage medium as in claim 8 wherein the time is indicated by an affordance comprising color.

15. A computer system comprising:
one or more processors;
a software program, executable on said computer system, the software program configured to:
cause an engine to receive temporal data from a source of time information;
cause the engine to receive geographic data from a source of geographic information;
cause the engine to provide an interface comprising a map view synchronized with a list view according to a time; and
cause the engine to change the interface according to a user input, such that synchronization between the map view and the list view is maintained.

16. A computer system as in claim 15 wherein the user input is provided to a timebar.

17. A computer system as in claim 16 wherein the user input comprises interacting with the timebar moveable within a lens portion.

18. A computer system as in claim 16 wherein the user input comprises interacting with the timebar comprising a playable frame portion.

19. A computer system as in claim 15 wherein the user input comprises a current location according to a global positioning system (GPS) signal, or comprises a past, present, or future location.

20. A computer system as in claim 15 wherein the user input comprises a current time according to pervasive time signal, or comprises a user-selected past, present, or future time.
